(19) United States
(12) Patent Application Publication
(10) Pub. No.: US 2023/0365207 A1
(43) Pub. Date: Nov. 16, 2023

(54) MULTI-FEATURE TRACK SYSTEM WITH ENHANCED PERFORMANCE

(71) Applicant: SOUCY INTERNATIONAL INC., Drummondville (CA)

(72) Inventors: Jeremie AUBIN-MARCHAND, St-Hugues (CA); Gabriel CHANTAL, Saint-Jude (CA)

(21) Appl. No.: 18/195,562

(22) Filed: May 10, 2023

Related U.S. Application Data
(60) Provisional application No. 63/341,161, filed on May 12, 2022.

(51) Int. Cl. B62D 55/15; B62D 55/125; B62D 55/084; B62D 55/065; B62D 55/10; B62D 55/108

(52) U.S. Cl. CPC B62D 55/15; B62D 55/065; B62D 55/084; B62D 55/10; B62D 55/1086; B62D 55/125

(57) ABSTRACT

A wheel assembly, a track system and a vehicle are disclosed. The track system has a frame defining a longitudinal center plane, a wheel assembly rotationally and pivotably connected to the frame, and the endless track having the inner surface and surrounding the frame and the wheel assembly. The wheel assembly has a non-linear axle and a wheel. The non-linear axle has a first segment and a second segment. The wheel is rotationally connected to the first segment extending along a rotation axis of the wheel. The second segment being pivotably connected to the frame. The second segment is offset from the first segment so that the second segment is closer to an inner surface of an endless track than the first segment.

### CROSS-REFERENCE TO RELATED APPLICATION

This application claims the benefit of and priority to U.S. Provisional Pat. Application No. 63/341,161, filed on May 12, 2022; the content of all of which is herein incorporated in entirety by reference.

### TECHNICAL FIELD

The present technology relates to track systems, vehicles having track systems, rear track system configurations, and wheel assemblies for track systems.

### BACKGROUND

Certain off-road vehicles, such as all-terrain vehicles (e.g. ATVs and UTVs), may be equipped with track systems which enhance their traction and floatation on soft, slippery and/or irregular grounds (e.g., soil, mud, sand, ice, snow, etc.) on which they operate. Track systems typically provides a larger contact area (patch) on the ground compared to the size of the contact area (patch) of a wheel on the ground. Floatation over soft, slippery and/or irregular ground surfaces is increased.

Track systems, due to the loads they bear and the conditions under which they are used may require maintenance operations and can require replacement of some parts, such as support wheel assemblies. These maintenance operations can be time consuming, can occur recurrently and can be expensive. Not performing these maintenance operations can reduce lifespan of other components of the track system. Furthermore, replacement of various parts of the track system can be expensive.

In order to reduce the aforementioned drawbacks, there is a desire for a track system and parts thereof that can, inter alia, reduce maintenance operations and enhance lifespan of various parts of the track system.

### SUMMARY

It is an object of the present technology to ameliorate at least some of the inconveniences present in the prior art.

Off-road vehicles can be equipped with one or more track systems. A track system generally includes a longitudinal frame, a plurality of wheel assemblies, and an endless track surrounding the frame and the plurality of wheel assemblies.

A variety of wheel assemblies can be configured for different functions. For example, a given wheel assembly may be configured to drive the endless track (e.g., a drive wheel assembly), guide the endless track (e.g., an idler wheel assembly), and/or support the load excreted on the track system (e.g., a support wheel assembly). It is contemplated that the given wheel assembly may be configured for more than one of the above-listed functions. For example, the given wheel assembly may be configured for both guiding the endless track and supporting the load excreted on the track system. Different configurations, also referred to as “layouts”, of the wheel assemblies on the track system are contemplated and depend on inter alia specific implementations of the present technology.

Broadly speaking, a given wheel assembly has an axle, one or more wheels rotationally connected to the axle, and the axle is connected at least indirectly to the frame of the track system. It is contemplated that the axle of the wheel assembly may be pivotably connected to the frame, which allows a pivoting motion of the wheels relative to a pivot axis.

A variety of structures are contemplated for providing the pivoting connection of the axle with the frame, without departing from the scope of the present technology. In some embodiments, the wheel assembly may comprise one or more resilient members that pivotably connect the axle to the frame.

In some embodiments of the present technology can be implemented similarly to what is disclosed in a co-owned U.S. Pat. Publication No. US2022/0089231, entitled “Support Structure for Connecting at Least One Support Wheel Assembly to a Frame Member of a Track System And Track System Having The Same”, and published on Mar. 24, 2022, the content of which is incorporated herein by reference in its entirety.

Developers of the present technology have realized that, although providing a pivotable wheel assembly on a track system can be advantageous, the pivoting motion of the wheels results in a lateral movement of the wheels relative to an inner surface of the endless track. This lateral movement can be detrimental to the track system in general and, more specifically, to the wheels and endless track.

A variety of wheel assemblies can be configured to operate with wheels of different diameters. For example, amongst a plurality of support wheel assemblies, the leading one thereof may be implemented with wheels of a larger diameter than the remainder thereof. The wheel diameters of respective wheels assemblies may depend on inter alia a specific configuration of the track system.

Developers of the present technology have also realized that, although providing a front support wheel assembly with wheels of a larger diameter can be beneficial, the “oversized” wheel assemblies are exposed to comparatively larger impact forces from obstacles located on the ground. These impact forces can be detrimental to the track system in general and, more specifically, to the wheel assemblies.

In some embodiments of the present technology, developers have devised a wheel assembly with a wheel and a non-linear axle having a first segment and a second segment. The wheel is rotationally connected to the first segment extending along a rotation axis of the wheel. The second segment is at least indirectly pivotably connected to the frame for allowing a pivoting motion of the wheel about a pivoting axis of the wheel assembly. The second segment is offset from the first segment. Pivotably connecting a second segment to the frame and which is offset from the first segment results in the pivoting axis extending at least one of (i) closer to an inner surface of the endless track than the rotation axis and (ii) further from an inner surface of the endless track than the rotation axis.

Developers of the present technology have realized that having the pivoting axis extending closer to the inner surface of the endless track reduces lateral movement of the wheel relating to the inner surface of the endless track during the pivoting motion.

In some embodiments, the non-linear axle may have the second segment offset from the first segment and extending parallel to the first segment. The first and second segments may be connected by a curved segment of the non-linear axle having a variety of shapes, such as but not limited to: an S-shape, a Z-shape, an L-shape, and a square shape. In one embodiment, the second segment may be parallel to the first segment and being offset from the first segment by a distance of 11 mm. Other offset distances between the first segment and the second segment are contemplated. In some embodiments, the offset distance between the first segment and the second segment may be a vertical distance.

In other embodiments, the non-linear axle may have the second segment offset from the first segment while not extending parallel to the first segment. Developers of the present technology have realized that such non-linear axles may be beneficial to compensate for inclination of the track systems about its roll axis, for instance. For example, one or more wheel assemblies of a track system may be provided with such non-linear axles to compensate for an aggressive camber angle of the vehicle and/or for a crowned road.

It is contemplated that a lower frame portion of the frame of the track system can include a flat frame segment and an angled frame segment extending forwardly and upwardly from the flat frame segment. As a result, the lower frame portion defines an angle between the flat frame segment and the angled frame segment. In these embodiments, developers have devised a wheel assembly that is rotationally and pivotably connected to the angled frame segment of the frame. A rotations axis of such a wheel assembly is therefore located vertically above a rotation axis of an other wheel assembly connected to the flat frame segment.

Developers of the present technology have realized that a wheel assembly connected to the angled frame segment, as opposed to one that is connected to the flat frame segment, allows to transfer a comparatively larger portion of an impact force (e.g., applied by an obstacle) along a vertical direction. It can be said that so-positioning the wheel assembly on the frame can, in a sense, “dampen” at least partially impact forces by working in compression and shear, rather than generally mainly in shear when the wheel assembly is connected to the flat frame segment.

In additional embodiments, the wheel assembly with a non-linear axle can be rotationally and pivotably connected to the angled frame segment of the frame. Developers of the present technology have realized that so-positioning the wheel assembly with the non-linear axle may further increase the “damping effect” provided by the wheel assembly during operation, since the non-linear axle provides in this configuration a lever-type action for the resilient member to better absorb impact forces from obstacles.

When the wheel assembly with a non-linear axle is rotationally and pivotably connected to the angled and/or flat frame segment of the frame, the offset between the first segment and the second segment of the non-linear axle may be said to be in a direction normal to the inner surface of the endless track. In those embodiments where the wheel assembly with a non-linear axle is rotationally and pivotably connected to the flat frame segment of the frame, the offset between the first segment and the second segment of the non-linear axle may be said to be a vertical offset.

In further embodiments, the track system may comprise a longitudinal guide rail that is connected to frame (either directly, or via one or more wheel assemblies of the track system) and which is spaced apart from the frame. In a first contemplated configuration of the track system, the wheel assembly with a non-linear axle may be rotationally and pivotably connected to the flat frame segment and the guide rail may be connected to the wheel assembly. In a second contemplated configuration of the track system, the wheel assembly with a non-linear axle may be rotationally and pivotably connected to the angled frame segment and the guide rail may be connected to the wheel assembly. In a third contemplated configuration of the track system, the wheel assembly with a non-linear axle may be rotationally and pivotably connected to the flat frame segment and the guide rail may be omitted. In a fourth contemplated configuration of the track system, the wheel assembly with a non-linear axle may be rotationally and pivotably connected to the angled frame segment and the guide rail may be omitted. In a fifth contemplated configuration of the track system, the wheel assembly with a non-linear axle may be rotationally and pivotably connected to the flat frame segment and/or the angled frame segment and have a wheel with a same diameter as wheels of other wheel assemblies. In a sixth contemplated configuration of the track system, the wheel assembly with a non-linear axle may be rotationally and pivotably connected to the flat frame segment and/or the angled frame segment and have a wheel with a different diameter as wheels of other wheel assemblies.

In a first broad aspect of the present technology, there is provided a track system. The track system comprises a frame defining a longitudinal center plane, and a wheel assembly rotationally and pivotably connected to the frame. The wheel assembly includes a non-linear axle and a wheel. The non-linear axle has a first segment and a second segment. The wheel is rotationally connected to the first segment extending along a rotation axis of the wheel. The second segment is pivotably connected to the frame. The second segment is offset from the first segment so that the second segment is closer to an inner surface of an endless track than the first segment. The endless track having the inner surface and surrounding the frame and the wheel assembly.

In some embodiments of the track system, the wheel assembly further has an other wheel. The non-linear axle further has an other first segment. The other first segment and the first segment are disposed on opposite ends of the second segment. The other wheel is rotationally connected to the other first segment extending along an other rotation axis of the other wheel.

In some embodiments of the track system, the track system further comprises a second wheel assembly disposed adjacent and longitudinally rearward from the wheel assembly. The second wheel assembly is rotationally and pivotably connected to the frame. The second wheel assembly has a linear axle and a second wheel. The linear axle extends along a second rotation axis of the second wheel rotationally connected to the linear axle. The linear axle is pivotably connected to the frame.

In some embodiments of the track system, the wheel has a first diameter, and the second wheel has a second diameter, the first diameter being larger than the second diameter.

In some embodiments of the track system, the frame has an upper frame portion and a lower frame portion. The lower frame portion has a flat segment and an angled segment. The angled segment extends from the flat segment forwardly and upwardly towards the upper frame portion, thereby defining an angle between the flat segment and the angled segment of the lower frame portion.

In some embodiments of the track system, the second segment of the non-linear axle is pivotably connected to the angled segment of the lower frame portion.

In some embodiments of the track system, the second segment of the non-linear axle is pivotably connected to the flat segment of the lower frame portion.

In some embodiments of the track system, the first segment and the second segment of the non-linear axle are integrally formed from a metallic material.

In some embodiments of the track system, the second segment is configured to pivot about a pivoting axis of the wheel assembly, the pivoting axis being perpendicular to the rotation axis of the wheel.

In some embodiments of the track system, the pivoting axis is further aligned with the frame.

In some embodiments of the track system, the pivoting axis extends through the second segment, the pivoting axis extending longitudinally and vertically below the rotation axis so as to reduce lateral movement of the wheel relative to the inner surface of the endless track.

In some embodiments of the track system, the second segment extends parallel to the first segment.

In some embodiments of the track system, the second segment does not extend parallel to the first segment.

In some embodiments of the track system, the non-linear axle is a curved axle further having a curved segment connecting the first segment and the second segment.

In some embodiments of the track system, the curved segment has one of a S-shape, a Z-shape, and a L-shape.

In some embodiments of the track system, the wheel assembly is a support wheel assembly from a plurality of support wheel assemblies longitudinally spaced along the frame.

In some embodiments of the track system, the support wheel assembly is disposed longitudinally forward from a remaining of the plurality of support wheel assemblies.

In some embodiments of the track system, the wheel assembly is a drive wheel assembly rotationally and pivotably connected to the frame for driving the endless track.

In some embodiments of the track system, the wheel assembly is an idler wheel assembly rotationally and pivotably connected to the frame.

In some embodiments of the track system, the track system further comprises a drive wheel assembly and an idler wheel assembly rotationally connected to the frame.

In some embodiments of the track system, the drive wheel assembly and the idler wheel assembly are further pivotably connected to the frame.

In some embodiments of the track system, the wheel assembly further comprises a resilient member for allowing pivoting movement of the wheel assembly.

In some embodiments of the track system, the track system further comprises a longitudinally extending guide rail connected to the resilient member and spaced apart from the endless track.

In some embodiments of the track system, the track system is for an off-road vehicle.

In some embodiments of the track system, the track system is a rear track system.

In some embodiments of the track system, the second segment is offset from the first segment in a direction that is normal to the inner surface of the endless track.

In some embodiments of the track system, the offset is a vertical offset.

In a second broad aspect of the present technology, there is provided a pivoting assembly for a track system. The pivoting assembly comprises a non-linear axle and a wheel. The non-linear axle has a first segment and a second segment. The wheel is rotationally connected to the first segment extending along a rotation axis of the wheel. The second segment is configured for pivotably connecting to a frame of the track system. The second segment is offset from the first segment so that the second segment is closer to an inner surface of an endless track of the track system than the first segment.

In some embodiments of the pivoting assembly, the pivoting assembly further has an other wheel. The non-linear axle further has an other first segment. The other first segment and the first segment are disposed on opposite ends of the non-linear axle. The other wheel is rotationally connected to the other first segment extending along an other rotation axis of the other wheel.

In some embodiments of the pivoting assembly, the first segment and the second segment of the non-linear axle are integrally formed from a metallic material.

In some embodiments of the pivoting assembly, the second segment is configured to pivot about a pivoting axis of the pivoting assembly, the pivoting axis being perpendicular to the rotation axis of the wheel.

In some embodiments of the pivoting assembly, the pivoting axis is further aligned with the frame.

In some embodiments of the pivoting assembly, the pivoting axis extends through the second segment, the pivoting axis extending longitudinally and vertically below the rotation axis so as to reduce lateral movement of the wheel relative to the inner surface of the endless track.

In some embodiments of the pivoting assembly, the second segment extends parallel to first segment.

In some embodiments of the pivoting assembly, the second segment does not extend parallel to the first segment.

In some embodiments of the pivoting assembly, the non-linear axle is a curved axle further having a curved segment connecting the first segment and the second segment.

In some embodiments of the pivoting assembly, the curved segment has one of a S-shape, a Z-shape, and a L-shape.

In some embodiments of the pivoting assembly, the pivoting assembly is a support wheel assembly.

In some embodiments of the pivoting assembly, the pivoting assembly is a drive wheel assembly.

In some embodiments of the pivoting assembly, the pivoting assembly is an idler wheel assembly.

In some embodiments of the pivoting assembly, the pivoting assembly further comprises a resilient member for allowing pivoting movement of the pivoting assembly relative to the frame.

In some embodiments of the pivoting assembly, the second segment is offset from the first segment in a direction that is normal to the inner surface of the endless track.

In some embodiments of the pivoting assembly, the offset is a vertical offset.

In a third broad aspect of the present technology, there is provided a vehicle comprising a vehicle frame, a seat disposed on the frame, a steering system operatively connected to the frame, a power source, and a track system operatively connected to the power source for driving the track system. The track system includes a frame defining a longitudinal center plane of the track system, and a wheel assembly rotationally and pivotably connected to the frame. The wheel assembly has a non-linear axle and a wheel. The non-linear axle has a first segment and a second segment. The wheel is rotationally connected to the first segment extending along a rotation axis of the wheel. The second segment is pivotably connected to the frame. The second segment is offset from the first segment so that the second segment is closer to an inner surface of an endless track than the first segment. The endless track has the inner surface surrounding the frame and the wheel assembly.

In some embodiments of the vehicle, the second segment is offset from the first segment in a direction that is normal to the inner surface of the endless track.

In some embodiments of the vehicle, the offset is a vertical offset.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of implementations of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1A is a left side elevation view of a vehicle having track systems according to embodiments of the present technology;

FIG. 1B is a top plan view of the vehicle of FIG. 1A;

FIG. 2A is a perspective view taken from a rear, top right side of a rear track system of the vehicle of FIG. 1A;

FIG. 2B is a left side elevation view of the rear track system of FIG. 2A;

FIG. 3A is a schematic right side elevation view of the rear track system of FIG. 2B in a first configuration;

FIG. 3B is a schematic right side elevation view of the rear track system of FIG. 2B in a second configuration;

FIG. 3C is a schematic right side elevation view of the rear track system of FIG. 2B in a third configuration;

FIG. 4 is a plurality of right side elevation views of various configurations of the rear track system of FIG. 2B;

FIG. 5 is a schematic right side elevation view of the rear track system of FIG. 2B in an alternative configuration;

FIG. 6 is a left side elevation view of the rear track system of FIG. 2A without an endless track, a guiding rail, and support wheels;

FIG. 7A is a cross-sectional view of the of the track system of FIG. 2B taken through line 7A-7A;

FIG. 7B is a cross-sectional view of the of the track system of FIG. 2B taken through line 7B-7B;

FIG. 8A is a schematic illustration of a non-linear axle having an S-shape;

FIG. 8B is a schematic illustration of a non-linear axle having a L-shape;

FIG. 8C is a schematic illustration of a non-linear axle having a Z-shape;

FIG. 8D is a schematic illustration of a non-linear axle having a square-shape;

FIG. 9A is a schematic illustration of a non-linear axle in a parallel configuration;

FIG. 9B is a schematic illustration of a non-linear axle in a first non-parallel configuration; and

FIG. 9C is a schematic illustration of a non-linear axle in a second non-parallel configuration.

### DETAILED DESCRIPTION

### Introduction

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including”, “comprising”, or “having”, “containing”, “involving” and variations thereof herein, is meant to encompass the items listed thereafter as well as, optionally, additional items. In the following description, the same numerical references refer to similar elements.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

It must be noted that, as used in this specification and the appended claims, the singular form “a”, “an” and “the” include plural referents unless the context clearly dictates otherwise.

As used herein, the term “about” in the context of a given value or range refers to a value or range that is within 20%, preferably within 10%, and more preferably within 5% of the given value or range.

As used herein, the term “and/or” is to be taken as specific disclosure of each of the two specified features or components with or without the other. For example, “A and/or B” is to be taken as specific disclosure of each of (i) A, (ii) B and (iii) A and B, just as if each is set out individually herein.

For purposes of the present application, terms related to spatial orientation when referring to a track system and components in relation to the track system, such as “vertical”, “horizontal”, “forwardly”, “rearwardly”, “left”, “right”, “above” and “below”, are as they would be understood by a driver of a vehicle to which the track system is connected sitting thereon in an upright driving position, with the vehicle steered straight-ahead and being at rest on flat, level ground.

Generally, the present technology relates to track systems and various features thereof such as layouts of the track systems, vehicles with the track systems, and wheel assemblies of the track systems.

### Off-Road Vehicle

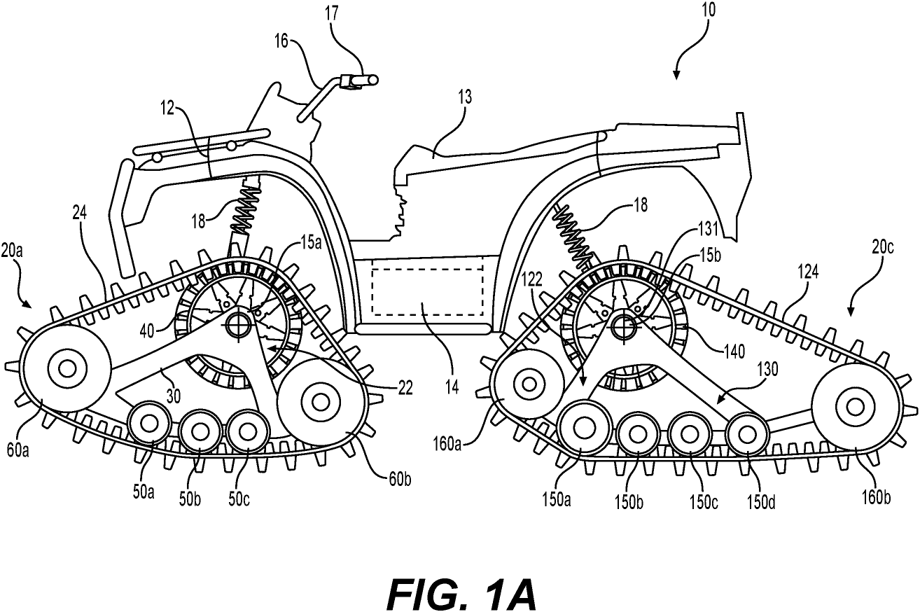

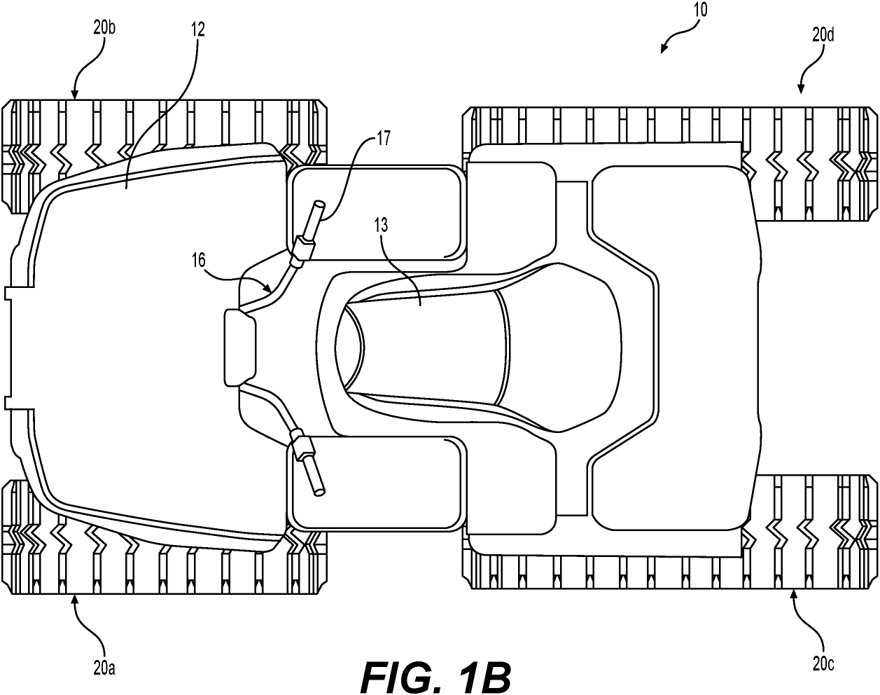

Referring to FIGS. 1A and 1B, the present technology will be described with reference to a vehicle 10. The vehicle 10 is an off-road vehicle 10. More precisely, the vehicle 10 is an all-terrain vehicle (ATV) 10. It is contemplated that in other embodiments, the off-road vehicle 10 could be as a side-by-side vehicle, a utility-task vehicle (UTV) or another type of recreational vehicles. A person skilled in the art will understand that it is also contemplated that some aspects of the present technology in whole or in part could be applied to other types of vehicles such as, for example, agricultural vehicles, industrial vehicles, military vehicles or exploratory vehicles for examples. The ATV 10 has four track systems 20a, 20b, 20c, 20d in accordance with embodiments of the present technology. The track systems 20a, 20b are front track systems, and the track systems 20c, 20d are rear track systems. In some embodiments, the off-road vehicle 10 could have more or less than four track systems.

The ATV 10 includes a frame 12, a straddle seat 13 disposed on the frame 12, a powertrain 14 (shown schematically), a steering system 16, a suspension system 18, and the four track systems 20a, 20b, 20c, 20d.

As will be described below, in various embodiments, the track systems 20a, 20b, 20c, 20d may have various features to enhance their traction and/or other aspects of their use and/or performance, such as, for example, features to ameliorate their manoeuverability, to better adapt to ground, and/or to improve overall ride quality.

The powertrain 14, which is supported by the frame 12, is configured to generate power and transmit said power to the track systems 20a, 20b, 20c, 20d via driving axles (not shown), thereby driving the ATV 10. More precisely, the front track systems 20a, 20b are operatively connected to a front axle 15a and, the rear track systems 20c, 20d are operatively connected to a rear axle 15b. It is contemplated that in some embodiments, the powertrain 14 could be configured to provide its motive power to both the front and the rear axles 15a, 15b, to only the front axle 15a or to only the rear axle 15b (i.e., in some embodiments, the front axle and/or rear axle could be a driving axle).

The steering system 16 is configured to enable an operator of the ATV 10 to steer the ATV 10. To this end, the steering system 16 includes a handlebar 17 that is operable by the operator to direct the ATV 10 along a desired course. In other embodiments, the handlebar 17 could be replaced by another steering device such as, for instance, a steering wheel. The steering system 16 is configured so that in response to the operator handling the handlebar 17, the front track systems 20a, 20b to change their orientation relative to the frame 12, thereby causing the ATV 10 to turn in a desired direction.

The suspension system 18, which is connected between the frame 12 and the track systems 20a, 20b, 20c, 20d, allows relative motion between the frame 12 and the track systems 20a, 20b, 20c, 20d, and can enhance handling of the ATV 10 by absorbing shocks and helping to maintain adequate traction between the track systems 20a, 20b, 20c, 20d and the ground.

The track systems 20a, 20b, 20c, 20d are configured to compensate for and/or otherwise adapt to the suspension system 18 of the ATV 10. For instance, the track systems 20a, 20b, 20c, 20d are configured to compensate for and/or otherwise adapt to alignment settings, namely camber (i.e., a camber angle, “roll”), caster (i.e., a caster angle, “steering angle” and/or toe (i.e., a toe angle, “yaw”), which are implemented by the suspension system 18. As the ATV 10 could have been originally designed to use wheels instead of the track systems, the alignment settings could originally have been set to optimize travel, handling, ride quality, etc. of the ATV 10 with the use of wheels. Since the track systems 20a, 20b, 20c, 20d are structurally different and behave differently from wheels, the track system 20a, 20b, 20c, 20d may be configured to compensate for and/or otherwise adapt to the alignment settings to enhance their traction and/or other aspects of their performances and/or use.

### Track System

In at least some embodiments of the present technology, the vehicle 10 may be equipped with one or more track systems described in a co-owned U.S. Pat. Application No. 17/575,478, entitled “Multi-Feature Track system with Enhanced Performance”, and filed on Jan. 13, 2022, the content of which is incorporated herein by reference in its entirety.

Focusing first on the front track systems 20a, 20b, since the front track systems 20a, 20b are similar (i.e., generally symmetrical about a longitudinal center plane of the ATV 10), only the front track system 20a, will be described herewith. The track system 20a is a front left track system that is operatively connected to the ATV 10. In some instances, the front left track system 20a could be configured to replace a front left wheel of the ATV 10.

The track system 20a, which has a front longitudinal end 21a and a rear longitudinal end 21b, includes a track-engaging assembly 22 and an endless track 24 that is disposed around the track-engaging assembly 22. The track-engaging assembly 22 includes a frame 30, a drive wheel assembly 40, three support wheel assemblies 50a, 50b, 50c and front and rear idler wheel assemblies 60a, 60b. It is contemplated that in some embodiments, there could be more or less than three support wheel assemblies and/or more or less than two idler wheel assemblies. In the present embodiment, each of the support wheel assemblies 50a, 50b, 50c and front and rear idler wheel assemblies 60a, 60b includes left and right wheels. Other configurations of the support and idler wheel assemblies are contemplated.

The front and rear idler wheel assemblies 60a, 60b are elevated relative to the support wheel assemblies 50a, 50b, 50c, and the support wheel 50a is elevated relative to the support wheel assemblies 50b, 50c. The elevation of the front idler wheel 60a, and the support wheel 50a can, in some instances, help the track system 20a to overcome obstacles (i.e., increase approach angle) and/or help the track system 20a to steer (i.e. minimize ground contacting surface). The same applies for the elevation of the rear idler wheel 60b as well (i.e. increase departure angle). In some embodiments, the front idler wheel assembly 60a and/or the rear idler wheel assembly 60b could bear weight, and thus could be considered to be support wheel assemblies. In some embodiments, the track system 20a includes an anti-rotation connector (not shown) as known in the art to limit a pivotal movement of the track system 20a relative to the frame 12 of the ATV 10. In some embodiments, the anti-rotation connector includes a resilient element such as a spring, or a member made of flexible material such as rubber, and a damper. The anti-rotation connector is connected between the frame 30 of the track system 20a and the frame 12 of the ATV 10. In some embodiments, the anti-rotation connector could be omitted. In some embodiments, one or more of the support wheels 50a, 50b, 50c could be elevated relative to the other support wheels (e.g., support wheel 50a is elevated relative to support wheels 50b and 50c).

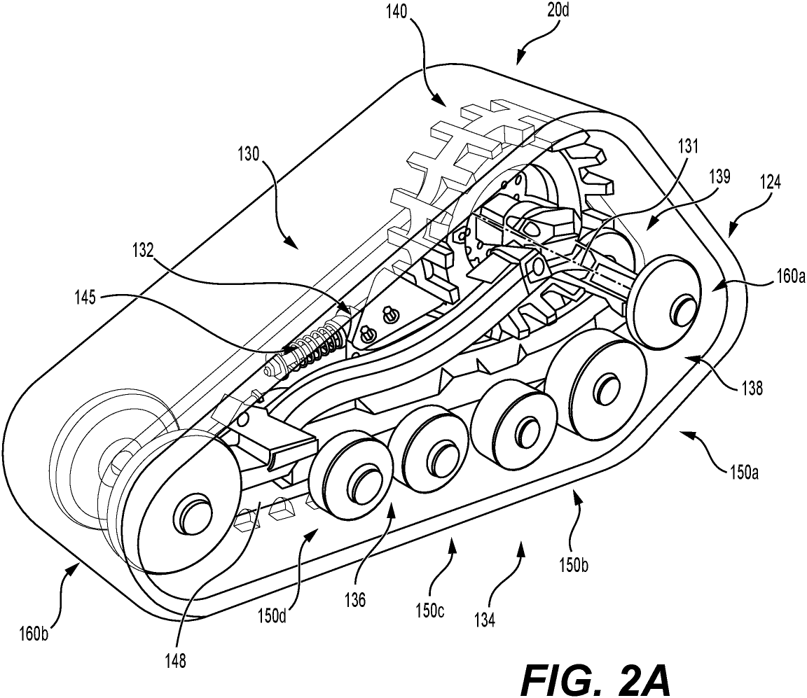

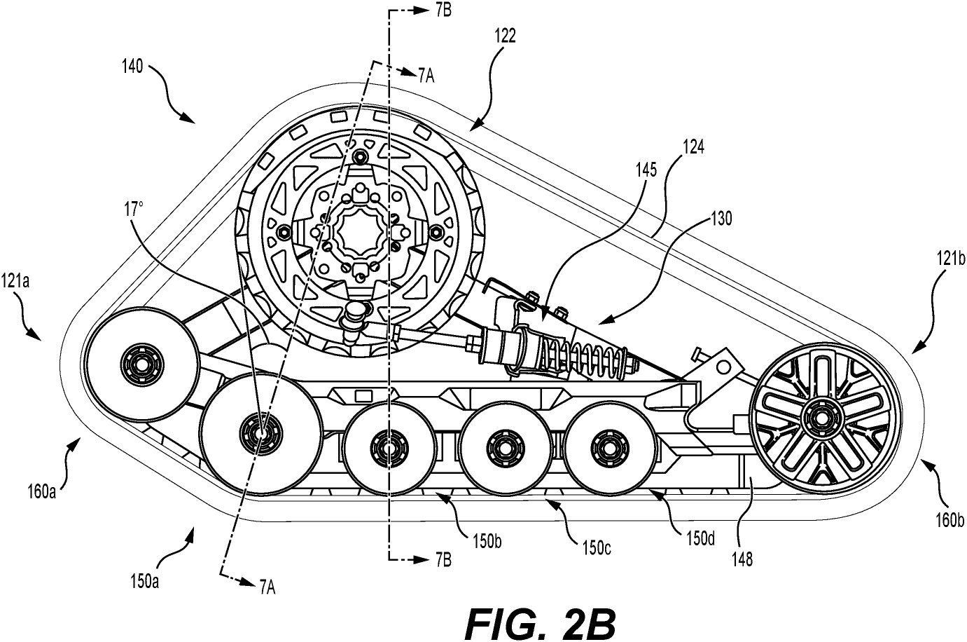

With reference to FIGS. 2A and 2B, as the rear track systems 20c, 20d are similar (i.e., generally symmetrical about a longitudinal center plane of the ATV 10), only the rear track system 20d will be described herewith. The track system 20d is a rear right track system configured to operatively connect to the ATV 10. In some instances, the rear right track system 20b is configured to replace a rear left wheel of the ATV 10.

The track system 20d, which has a front longitudinal end 121a and a rear longitudinal end 121b, includes a track-engaging assembly 122 and an endless track 124 disposed around the track-engaging assembly 122. The track-engaging assembly 122 includes a frame 130, a drive wheel assembly 140, four support wheel assemblies 150a, 150b, 150c, 150d and front and rear idler wheel assemblies 160a, 160b. It is contemplated that in some embodiments, there could be more or less than three support wheel assemblies and/or more or less than two idler wheel assemblies. In the present embodiment, each of the support wheel assemblies 150a, 150b, 150c, 150d and front and rear idler wheel assemblies 160a, 160b includes left and right wheels. Other configurations of the support and idler wheel assemblies are contemplated.

In this embodiment, the diameter of the support wheel assembly 150a is larger than the diameter of the support wheel assemblies 150b, 150c, 150d. It can be said that a wheel of the leading support wheel assembly 150a has a larger diameter than wheels of other support wheel assemblies 150b, 150c, 150d.

In this embodiment, the front and rear idler wheel assemblies 160a, 160b are elevated relative to the support wheel assemblies 150b, 150c, 150d. The support wheel assembly 150a is also elevated relative to the support wheel assemblies 150b, 150c, 150d. The elevation of the front idler wheel assembly 160a can, in some instances, assist the track system 20d to overcome obstacles (i.e., increase approach angle). The same applies for the elevation of the support wheel assembly 150a (i.e., increase approach angle) and for the elevation of the rear idler wheel 60b as well (i.e., increase departure angle).

It should be noted that the configuration of the support wheel assemblies 150a, 150b, 150c, 150d and the front and rear idler wheel assemblies 160a, 160b could be different without departing from the scope of the present technology. In some embodiments, the front idler wheel assembly 160a and/or the rear idler wheel assembly 160b could bear weight, and thus could be considered to be support wheel assemblies.

The track system 20d comprises an anti-rotation connector 145 as known in the art to limit a pivotal movement of the track system 20d relative to the frame 12 of the ATV 10. The anti-rotation connector 145 includes a resilient element such as a spring, but can also include a member made of flexible material such as rubber, and a damper. The anti-rotation connector 145 is connected between the frame 130 of the track system 20d and the frame 12 of the ATV 10. In some embodiments, the anti-rotation connector 145 could be omitted.

The track system 20d comprises a guide rail 148 extending longitudinally along the frame 130. The guide rail 148 is connected to the frame 130 via one or more components of the support wheel assemblies 150a-d. In other embodiments, the guide rail 148 can be connected directly to the frame 130. The guide rail 148 is provided between the frame 130 and the endless track and is spaced apart from the endless track 124. In further embodiments, the guide rail 148 could be omitted.

### Rear Track Configuration

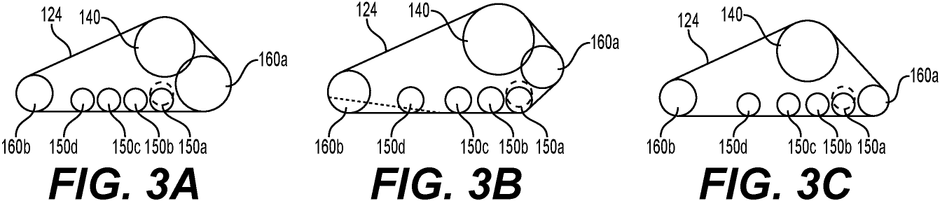

Referring to FIGS. 3A-C, 4, and 5, various configurations of the track system 20d will be described. The configuration of a track system is sometimes referred to as a “layout” of the track system.

The configuration of the track system 20d can vary, depending on which aspect of the overall performance of the track system 20d is to be prioritized. The configuration, and thus aspects of the overall performance, of the track system 20d, can change depending on, for example, the size of the support wheel assemblies 150a, 150b, 150c, 150d, the size of the front and rear idler wheel assemblies 160a, 160b, the positioning of the support wheel assemblies 150a, 150b, 150c, 150d, the positioning of the front and rear idler wheel assemblies 160a, 160b, as well as the number of the support wheel assemblies 150a, 150b, 150c, 150d and the number of the idler wheel assemblies 160a, 160b. The positioning and size of the drive wheel assembly 140 can also impact the overall performance of the track system 20d. Some of these configurations, without being limited to these configurations, are shown in FIGS. 3A-C, 4, and 5.

Referring to FIG. 3A, in some instances, increasing the diameter of one or both of the idler wheel assemblies 160a, 160b increases the durability of the track system 20d. An increase in diameter of an idler wheel assembly (e.g., front idler wheel assembly 160a as shown in FIG. 3A,) reduces stresses generated in the endless track 124 where the endless track 124 surrounds the idler wheel assembly due to the endless track 124 having a larger radius of curvature at that point. Additionally, increasing the distance between the support wheel assemblies 150a, 150b, 150c, 150d, the idler wheel assemblies 160a, 160b and the drive wheel assembly 140 generally results in increasing the contact surface (i.e., “contact patch”) between the endless track 124 and the ground (for example: increasing the distance between each one of the support wheel assemblies 150a, 150b, 150c, 150d; increasing the distance between the support wheel assemblies 150a, 150b, 150c, 150d and any one of the idler wheel assemblies 160a; 160b; increasing the distance between the support wheel assemblies 150a, 150b, 150c, 150d and the drive wheel assembly 140; increasing the distance between any one of the idler wheel assemblies 160a, 160b and the drive wheel assembly 140; increasing the distance between the support wheel assemblies 150a, 150b, 150c, 150d and the drive wheel assembly 140; and/or increasing the distance between the support wheel assemblies 150a, 150b, 150c, 150d, the idler wheel assemblies 160a, 160b and the drive wheel assembly 140). An increase in the area of contact between the endless track 124 and the ground reduces pressure in the endless track 124, which increases durability of the track system 20d.

Referring to FIG. 3B, positioning the front idler wheel assembly 160a in an uplifted position relative to the ground (and thus relative to the support wheels 150a, 150b, 150c, 150d) is believed to improve the ability of the track system 20d to climb over obstacles. The uplifted position of the front idler wheel assembly 160a provides a greater “approach angle”, which facilitates obstacle climbing.

Referring to FIG. 3C, decreasing the diameter of one of the front and rear idler wheel assemblies 160a, 160b (front idler wheel assembly 160a in the present embodiment) so that the diameter thereof is substantially similar to the diameter of the support wheel assemblies 150a, 150b, 150c, 150d and positioned so that the front idler wheel assembly 160a is generally level with the support wheel assemblies 150a, 150b, 150c, 150d which is believed to improve traction and floatability of the track system 20d, as the contact surface between the endless track 124 and the ground increases. In such embodiments, the front idler wheel assembly 160a is considered as a support wheel.

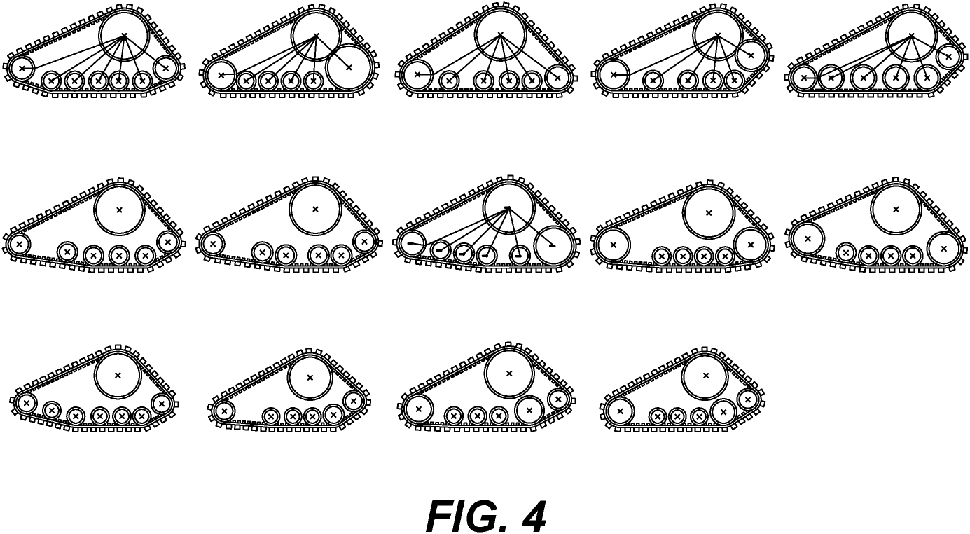

Referring to FIG. 4, various configurations of the track system 20d are shown, where each configuration slightly modifies one of the aspects of the overall performance of the track system 20d, such as the durability, the obstacle crossing, the traction and floatability.

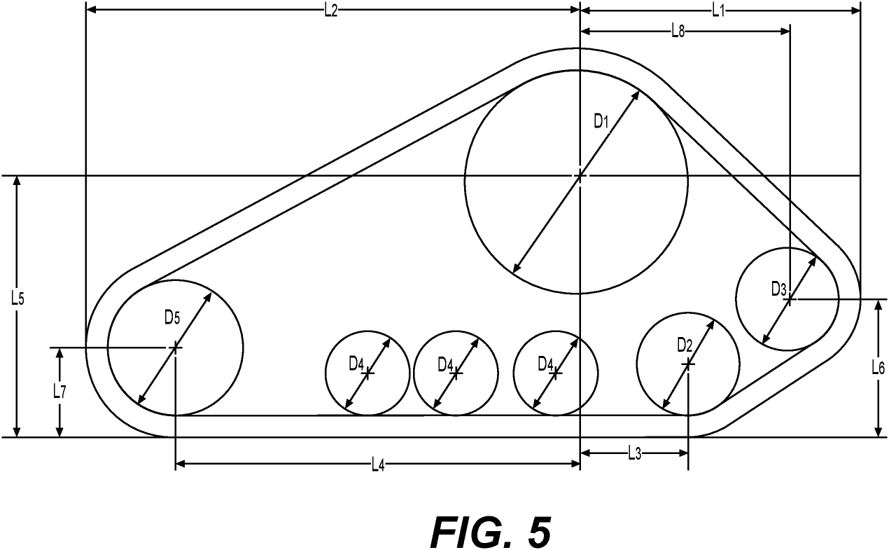

Referring to FIG. 5, a first embodiment of the configuration of the track system 20d is shown. This configuration is particularly suited for durability and traction/floatation purposes. In this configuration, the diameter of the leading support wheel assembly 150a is larger than the diameter of the other support wheel assemblies 150b, 150c, 150d, which as will be described below, is believed to improve durability of the track system 20d. Additionally, the rear idler wheel assembly being substantially level with the support wheel assemblies 150a, 150b, 150c, 150d increases the contact surface between the endless track 124 and the ground, thereby enhancing traction/floatation. A length L1 is measured between a center of the drive wheel assembly 140 and the front longitudinal end 121a. A length L2 is measured between the center of the drive wheel assembly 140 and the rear longitudinal end 121b. A length L3 is measured between the center of the drive wheel assembly and the center of the support wheel assembly 150a. A length L4 is measured between the center of the drive wheel assembly and the center of the rear idler wheel assembly 160b. A length L5 is measured between the center of the drive wheel assembly and the ground (i.e., bottom of the endless track 124). A length L6 is measured between the center of the leading idler wheel assembly 160a and the ground (i.e., bottom of the endless track 124). A length L7 is measured between the center of the rear idler wheel assembly 160b and the ground (i.e., bottom of the endless track 124). A length L8 is measured between the center of the drive wheel assembly 140 the center of the front idler wheel assembly 160b. In the present embodiment, L1 is about 457 mm, L2 is about 855 mm, L3 is about 150 mm, L4 is about 701 mm, L5 is about 439 mm, L6 is about 238 mm, L7 is about 157 mm and L8 is about 331 mm. The drive wheel assembly 140d defines a diameter D1. The support wheel assembly 150a defines a diameter D2. The front idler wheel assembly 160a defines a diameter D3. The support wheel assemblies 150b, 150c, 150d define diameter D4. It is contemplated that in some embodiments, each of the support wheel assemblies 150b, 150c, 150d could define diameters different from one another. The rear idler wheel assembly 160b defines a diameter D5. In the present embodiment, D1 is about 378 mm, D2 is about 190 mm, D3 is about 175 mm, D4 is about 144 mm and D5 is about 230 mm. Various ratios can be derived from these dimensions. It is contemplated that L1-L8 and D1-D5 could have other values in other embodiments without departing from the scope of the present technology.

In some embodiments, the configuration of the track system 20d could be adapted so that a larger portion of the contact surface between the endless track 124 and the ground is located in front of the axle of the ATV 10 to which the track system 20d is operatively connected (rear axle 15b). This, inter alia, avoids the need for a powerful anti-rotation connector.

Returning to FIGS. 2A and 2B, the track system 20d is longitudinally asymmetrical about a vertical plane that passes through the rear axle and that is generally perpendicular to a longitudinal center plane of the track system 20d. More precisely, generally, the rear axle 15b is closer to the front longitudinal end 121a of the track system 20d than to the rear longitudinal end 121b of the track system 20d. As a result, there is an unequal load distribution of the load borne by the track system 20d, as the loads are greater toward the front longitudinal end 121a of the track system 20d than toward the rear longitudinal end 121b of the track system 20d.

As a result, the load exerted on the support wheel assembly 150a is generally greater than the load exerted on the other support wheel assemblies 150b, 150c, 150d. This, in turn, results in a higher pressure being applied on the endless track 124 below the support wheel assembly 150a than below the support wheels 150b, 150c, 150d when the support wheel assemblies 150a, 150b, 150c, 150d have a similar size.

In the present embodiment, being that the support wheel assembly 150a has a larger diameter than the support wheel assemblies 150a, 150b, 150c, 150d, the area of contact between the support wheel assembly 150a and the endless track 124 increases longitudinally. An increase in the area of contact between the support wheel assembly 150a and the endless track 124 results in a reduction of the pressure applied by the support wheel assembly 150a to the endless track 124. Thus, wear on the endless track 124 and on the support wheel assembly 150a is reduced. This is particularly beneficial, as the leading support wheel assemblies are generally one of the first parts of track systems that need to be replaced due to wear. Furthermore, an increase in the diameter of the support wheel assembly 150a can reduce the slippage between the endless track 124 and the ground where the endless track 124 initially engages the ground (i.e., below the support wheel assembly 150a) as the contact area between the endless track 124 and the ground is increased. A reduction in slippage reduces wear on the endless track 124. In addition, the larger diameter of the support wheel assembly 150a implies a larger lateral surface of the wheel, which in turn reduces wear caused by the support wheel assembly 150a and lugs 610 disposed on the endless track 124. As such, wear on the support wheel assembly 150a is reduced. In other words, a wheel with a larger diameter that engages the lug 610 undergoes wear, but slower than the wear undergone by a wheel with a smaller diameter, as a larger diameter will have less revolutions than the smaller diameter for a given distance. This is particularly beneficial, because the leading support wheel assemblies are generally one of the first parts of track systems that need to be replaced due to wear. It is believed that a wheel with a larger diameter travels a larger horizontal distance when overcoming an obstacle of a given height, when compared to a wheel with a smaller diameter, such that the vertical upward and downward motions resulting from the overcoming of obstacles is spread over a larger horizontal distance when the wheel has a larger diameter, which therefore enhances ride quality by reducing vibrations and shocks.

As it will be described in greater details herein further below, developers of the present technology have realized that connecting the support wheel assembly 150a on an angled portion of the frame 130 may be beneficial for the performance of the track system 20d. In some embodiments, when impacting an obstacle on a ground surface, the support wheel assembly 150a connected to the angled portion of the frame 130, as opposed to a flat portion of the frame 130 for example, may absorb a comparatively larger portion of the impact force applied to the support wheel assembly 150a. It can be said that so-connecting the support wheel assembly 150a may allow one or more resilient members of the support wheel assembly 150a to, in a sense, “dampen” at least partially the impact by working in compression and in shear rather than generally mainly in shear.

### Frame

The frame 130 is pivotable about a pivot axis 131 (i.e. pitch), which can facilitate motion of the track system 20d on uneven terrain, and enhance traction thereof. More particularly, in the present embodiment, the pivot axis 131 is aligned with the rear axle 15b, and aligned with an axis of rotation of the drive wheel assembly 140. In other embodiments, the pivot axis 131 of the frame 130 could be offset from the axis of rotation of the drive wheel assembly 140. In yet other embodiments, the frame 130 could be fixed (i.e., not pivotable).

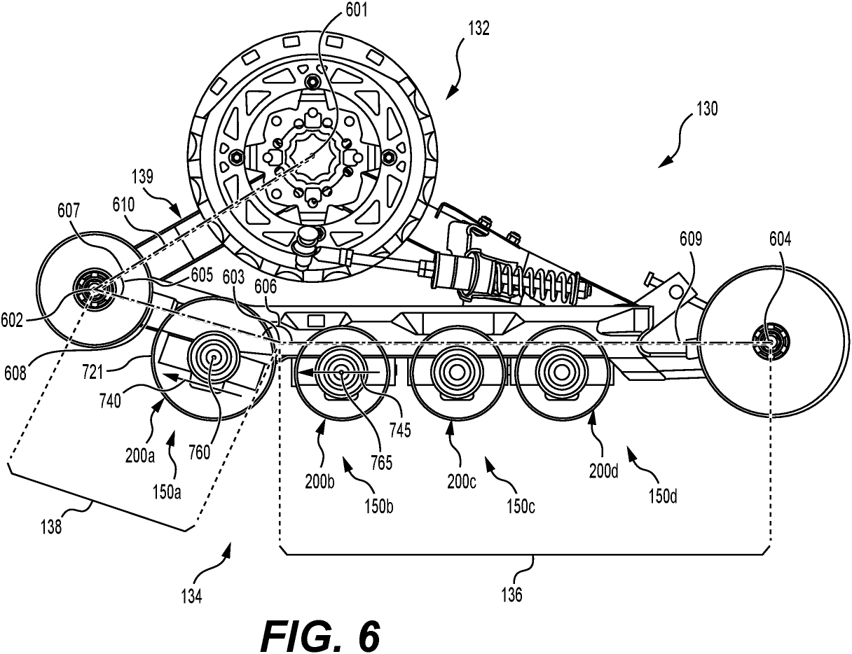

With reference to FIG. 6, in this embodiment, the frame 130 includes an upper frame portion 132 and a lower frame portion 134. The upper frame portion 132 is configured to rotationally connect with the drive wheel assembly 140. The lower frame portion 134 is configured to rotationally connect with the front and rear idler wheel assemblies 160a, 160b. More precisely, the front idler wheel assembly 160a is connected to the lower frame portion 134 at the front longitudinal end 121a of the track system 20d, and the rear idler wheel assembly 160b is connected to the lower frame portion 134 at the rear longitudinal end 121b of the track system 20d.

The lower frame portion 134 is configured to rotationally and pivotably connect with the support wheel assemblies 150a, 150b, 150c, 150d. The support wheel assemblies 150a, 150b, 150c, 150d are disposed longitudinally between the front and rear idler wheel assemblies 160a, 160b. In some embodiments, two or more of the support wheel assemblies 150a, 150b, 150c, 150d could be connected to the lower frame portion 134 via a tandem pivot assembly, as generally known in the art.

The upper frame portion 132 includes a front frame segment 139 extending along a line 610 passing through a point 601 corresponding to a center of rotation of the drive wheel assembly 140 and a point 602 corresponding to a center of rotation of the front idler wheel 160a.

The lower frame portion 134 includes a flat segment 136 extending along a line 609 passing through a point 604 corresponding to a center of rotation of the rear idler wheel 160b and a point 603. The lower frame portion 134 also includes an angled segment 138 extending along a line 608 passing through the point 603 and the point 602. The angled segment 138 extends forwardly and upwardly from the point 603 towards the front frame segment 139.

In this embodiment, the lower frame portion 134 defines an angle 606 between the line 608 and the line 609 - that is, the flat segment 136 and the angled segment 138 are disposed at the angle 606 with one another. In this embodiment, the angle 606 is 163 degrees.

As mentioned above, the support wheel assemblies 150a, 150b, 150c, 150d are rotationally and pivotably connected to the lower frame portion 134. In this embodiment, the support wheel assembly 150a (the leading support wheel assembly) is rotationally and pivotably connected to the angled segment 138 of the lower frame portion 134, while the remaining support wheel assemblies 150b, 150c, 150d are rotationally and pivotably connected to the flat segment 136 of the lower frame portion 134.

It is contemplated however that more than one most forwardly support wheel assemblies may be connected to the angled segment 138 of the lower frame portion, and/or all support wheel assemblies may be connected to the flat segment 136, without departing from the scope of the present technology.

### Support Wheel Assemblies

Broadly speaking, a given support wheel assembly comprises an axle, one or more corresponding support wheels rotationally attached to the axle, and a member allowing pivotable movement of the axle relative to the lower frame portion 134. The member may include a support structure for pivoting connection of the axle to the lower frame portion 134. In this embodiment, the support wheel assemblies 150a, 150b, 150c, 150d are pivotably connected to the lower frame portion 134, such that each axle of the support wheel assemblies 150a, 150b, 150c, 150d is pivotable relative to the lower frame portion 134. It is contemplated that each axle of the support wheel assemblies 150a, 150b, 150c, 150d are pivotable relative to the lower frame portion 134 and independently from one another.

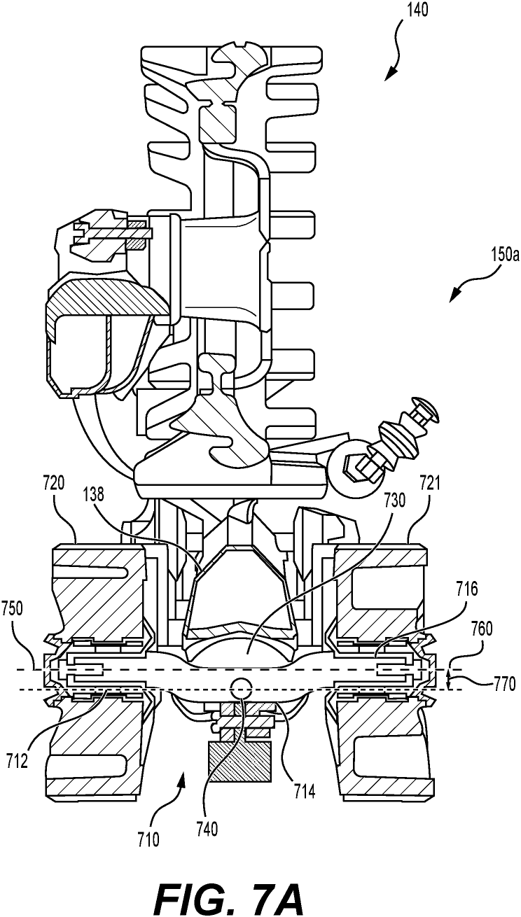

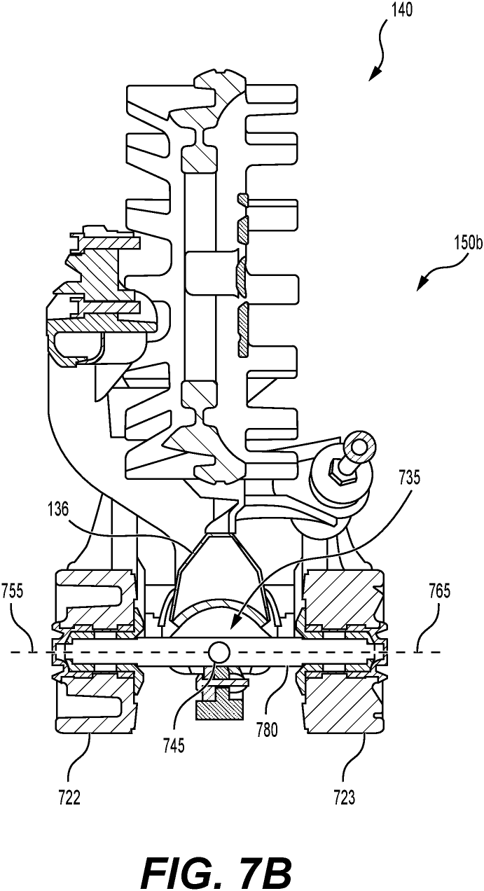

On the one hand, a support wheel 721 of the support wheel assembly 150a has a rotation axis 760 (extending out of the FIG. 6) and an axle 710 (best seen in FIG. 7A) of the support wheel assembly 150a is pivotable about a pivot axis 740 aligned with the angled frame segment 138. On the other hand, a support wheel 723 of the support wheel assembly 150b has a rotation axis 765 (extending out of the FIG. 6) and an axle 780 (best seen in FIG. 7B) of the support wheel assembly 150b is pivotable about a pivot axis 745 aligned with the flat frame segment 136.

It should be noted the pivot axis 740 of the axle 710 of the support wheel assembly 150a is offset from the rotation axis 760 of the support wheel 721 of the support wheel assembly 150a, while the pivot axis 745 and the rotation axis 765 of the support wheel assembly 150b are aligned. Developers of the present technology have realized that having a pivoting axis offset, in a direction normal to an inner surface of the endless track 124, from a respective rotation axis allows reducing lateral movement of the corresponding support wheel relative to an inner surface of the endless track 124.

As it will be described in greater details herein below, the support wheel assembly 150a comprises one or more component(s) that are different from the components of the support wheel assemblies 150b, 150c, 150d, allowing for a such an offset between its pivot axis and the rotation axis of a corresponding wheel. In other embodiments of the present technology, it is contemplated that more than one, and/or all support wheel assemblies of a given track system may be implemented similarly to how the support wheel assembly 150a is implemented. Additionally, and/or optionally, other wheel assemblies of a given track system (such as idler wheel assemblies and/or drive wheel assemblies, for example) may comprise one or more components of the support wheel assembly 150a for rotational and pivoting connection of a respective wheel assembly to the frame 130.

### Embodiments of Support Wheel Assemblies

With reference to FIGS. 7A and 7B, there is depicted cross-sectional views of the track system 20d passing through lines 7A-7A and 7B-7B, respectively. The cross-section view passing through the line 7A-7A shows components of the support wheel assembly 150a, and the cross-section view passing through the line 7B-7B shows components of the support wheel assembly 150b.

In FIG. 7A, there is depicted the support wheel assembly 150a comprising the non-linear axle 710, a pair of support wheels 720 and 721, and a resilient member 730. The support wheels 720, 721 are rotationally connected to the non-linear axle 710 on opposite ends thereof. The resilient member 730 pivotably connects the non-linear axle 710 to the angled segment 138 of the lower frame portion 134.

In this embodiment, the resilient member 730 is configured to allow pivoting motion of the support wheel assembly 150a. When the non-linear axle 710 of the support wheel assembly 150a pivots, the resilient member 730 resiliently deforms. Upon deformation, the resilient members 730 bias the non-linear axle 710 of the support wheel assembly 150a toward an initial position. Thus, the resilient member 730 may enhance load distribution of the track system 20d, and can help the track system 20d to overcome obstacles.

In this embodiment, the resilient member 730 is configured to allow movement of the non-linear axle 710 relative to the frame 130 and/or to the drive wheel assembly 140 and about the pivoting axis 740. Thus, upon impact (e.g. due to an obstacle crossing) on the support wheel assemblies 150a, rotation axes 750, 760 are movable relative to the frame 130 and/or to the drive wheel assembly 140 from an initial/rest position to a plurality of directions that are transversal to one another. In some embodiments, translational movements relative to the frame 130 are allowed.

In FIG. 7B, there is depicted the support wheel assembly 150b. The support wheel assembly 150b comprises the straight axle 780, a pair of support wheels 722 and 723, and a resilient member 735. The support wheels 722, 723 are rotationally connected to the straight or linear axle 780 on opposite ends thereof. The resilient member 735 pivotably connects the straight axle 780 to the flat segment 136 of the lower frame portion 134.

In this embodiment, the resilient member 735 is configured to allow pivoting motion of the support wheel assembly 150b. When the linear axle 780 of the support wheel assembly 150b pivots, the resilient member 735 resiliently deforms. Upon deformation, the resilient members 735 bias the linear axle 780 of the support wheel assembly 150b toward an initial position. Thus, the resilient member 735 may enhance load distribution of the track system 20d, and can help the track system 20d to overcome obstacles.

In this embodiment, the resilient member 735 is configured to allow movement of the linear axle 780 relative to the frame 130 and/or to the drive wheel assembly 140 and about the pivoting axis 745. Thus, upon impact (e.g. due to an obstacle crossing) on the support wheel assemblies 150b, rotation axes 755, 765 are movable relative to the frame 130 and/or to the drive wheel assembly 140 from an initial/rest position to a plurality of directions that are transversal to one another. In some embodiments, translational movements relative to the frame 130 are allowed.

It should be noted that, as opposed to the support wheel assembly 150b, the support wheel assembly 150a is rotationally and pivotably connected to the angled frame segment 138 instead of the flat frame segment 136. Developers of the present technology have realized that such location of the support wheel assembly 150a on the angled frame segment 138 allows to transfer a comparatively larger portion of the impact force along a vertical direction than the support wheel assembly 150b located on the flat frame segment 136. It can be said that the support wheel assembly 150a located on the angled frame segment 138 can “dampen” at least partially the impact force caused by an obstacle by working in compression in addition of in shear.

It should also be noted that, as opposed to the straight axle 780 of the support wheel assembly 150b, the support wheel assembly 150a has the non-linear axle 710 comprising first segments 712 and 716, and a second segment 714. The second segment 714 is offset from the first segments 712, 716 in a direction that is normal to the inner surface of the endless track 124. The first segment 712 extends along a rotation axis 750 of the wheel 720 and the first segment 716 extends along the rotation axis 760 of the wheel 721. The second segment 714 is pivotably connected to the lower frame portion 134 via the resilient member 730.

Since the second segment 714 is so-offset from the rotation axes 750, 760 and pivotably connects the non-linear axle 710 to the lower frame portion 134, the pivoting axis 740 of the support wheel assembly 150a is also offset from the rotation axes 750, 760 in a direction normal to the inner surface of the endless track 124. Developers of the present technology have realized that so-offsetting the pivoting axis 740 from the rotation axes 750, 760, allows reducing a distance between the pivoting axis 740 of the support wheel assembly 150a and the internal surface of the endless track 124. Developers have also realized that reducing the distance between the pivoting axis 740 of the support wheel assembly 150a and the internal surface of the endless track 124 in turn reduces lateral movement of the support wheels 720, 721 relative to the inner surface of the endless track 124 during the pivoting motion, thereby decreasing wear of the support wheels 720, 721 and/or of the endless track 124.

It can also be said that, as opposed to the straight axle 780 which extends along rotation axes 755 and 765 of the wheels 722 and 723 and where the pivoting axis 745 is aligned with the rotation axes 755, 765, the non-linear axle 710 of the support wheel assembly 150a therefor provides a pivoting axis that is comparatively closer to the inner surface of the endless track 124 if placed on a same frame segment of the lower frame portion 134.

In this embodiment, an offset distance 770 between the rotation axes 750, 760 and the pivoting axis 740 is 11 mm. However, the offset distance 770 may be vary depending on inter alia a specific implementation of the present technology.

The offset distance 770 of the offset may depend on inter alia specific embodiments of the present technology. In some embodiments, the offset may be limited by a vertical height of the guiding rail 148. In those embodiments where the guiding rail 148 is omitted, the offset may be limited by a minimum spacing necessary so that no components of the support wheel assembly 150a, other than the wheels 720, 721, are in contact with the inner surface of the endless track 124.

In some embodiments, the offset may need to compensate for a difference between a diameter between the wheel 721 of the support wheel assembly 150a and a diameter of the wheel 723 of the support wheel assembly 150b.

In other embodiments, the offset may need to compensate for the difference between (i) a height at which the support wheel assembly 150a is located on the angled frame segment 138 and (ii) a height at which the support wheel assembly 150b is located on the flat segment 136 - where the difference in heights is caused by the angle 606 of the lower frame portion 134.

In further embodiments, the offset may be selected so that pivoting axes of respective support wheel assemblies are substantially at a same height from the ground surface, and that, irrespective of whether the respective support wheel assemblies have wheels of same or different diameters.

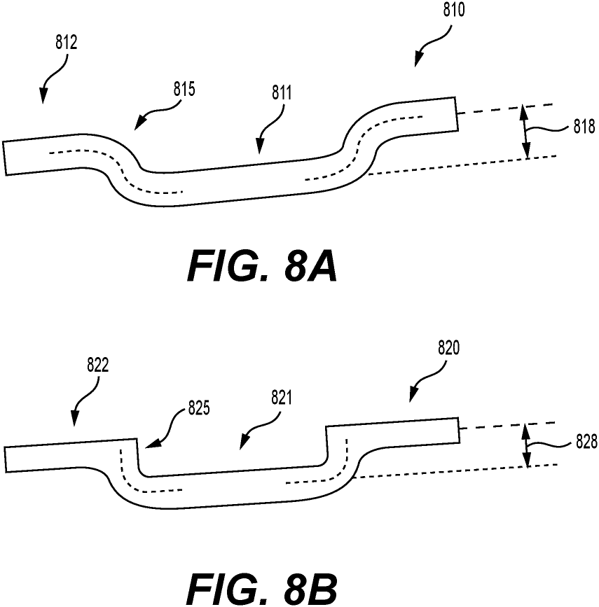

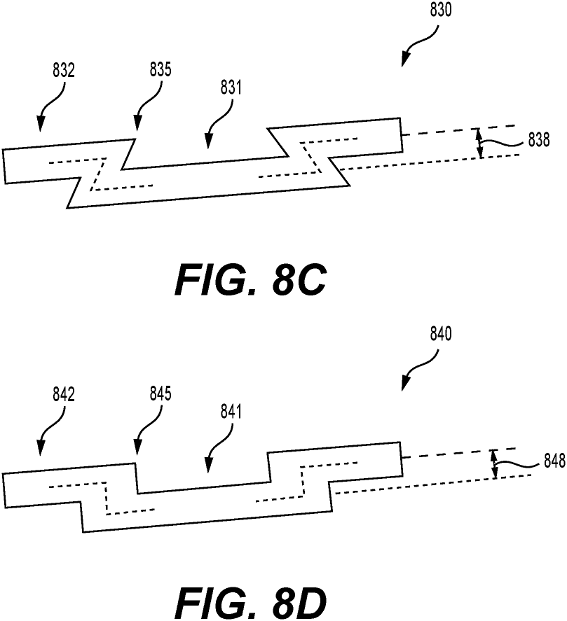

The shape of the non-linear axle 710 may also depend on inter alia a specific embodiment of the present technology. With reference to FIGS. 8A to 8D, there is depicted a variety of different shapes of a non-linear axle for a wheel assembly as contemplated in some embodiments of the present technology.

In FIG. 8A, there is depicted a non-linear axle 810 having a first segment 812 and a second segment 811. The first segment 812 and the second segment 811 are connected by a curved segment 815. The curved segment 815 has an S-shape. The first segment 812 is offset by an offset distance 818 from the second segment 811. In FIG. 8B, there is depicted a non-linear axle 820 having a first segment 822 and a second segment 821. The first segment 822 and the second segment 821 are connected by a curved segment 825. The curved segment 825 has an L-shape. The first segment 822 is offset by an offset distance 828 from the second segment 821. In FIG. 8C, there is depicted a non-linear axle 830 having a first segment 832 and a second segment 831. The first segment 832 and the second segment 831 are connected by a curved segment 835. The curved segment 835 has a Z-shape. The first segment 832 is offset by an offset distance 838 from the second segment 831. In FIG. 8D, there is depicted a non-linear axle 840 having a first segment 842 and a second segment 841. The first segment 842 and the second segment 841 are connected by an intermediary segment 845. The intermediary segment 845 has a square-shape. The first segment 842 is offset by an offset distance 848 from the second segment 841.

It is contemplated that a non-linear axle may be implemented as a curved axle having a curved segment connecting the first segment and the second segment thereof. However, other non-linear axles having other intermediary segments to those non-exhaustively illustrated in FIGS. 8A to 8D are contemplated without departing from the scope of the present technology.

It is contemplated that when a given one amongst the non-linear axles 810, 820, 830, and 840 is employed in a given wheel assembly, the corresponding offset distances 818, 828, 838, and 848 are in a direction that is normal to the inner surface of the endless track 124. However, in those embodiments where the given wheel assembly is located on a flat frame segment of the lower frame portion, the corresponding offset distances 818, 828, 838, and 848 are distances in a vertical direction.

It should also be noted that, although the non-linear axles 810, 820, 830, 840 have respective second segments 811, 821, 831, 841 that are parallel with respective first segments 812, 822, 832, 842, this may not be the case in each and every embodiment of the present technology. In some embodiments, developers have devised non-linear axles for wheel assemblies where the second segment is not extending parallel to the first segment.

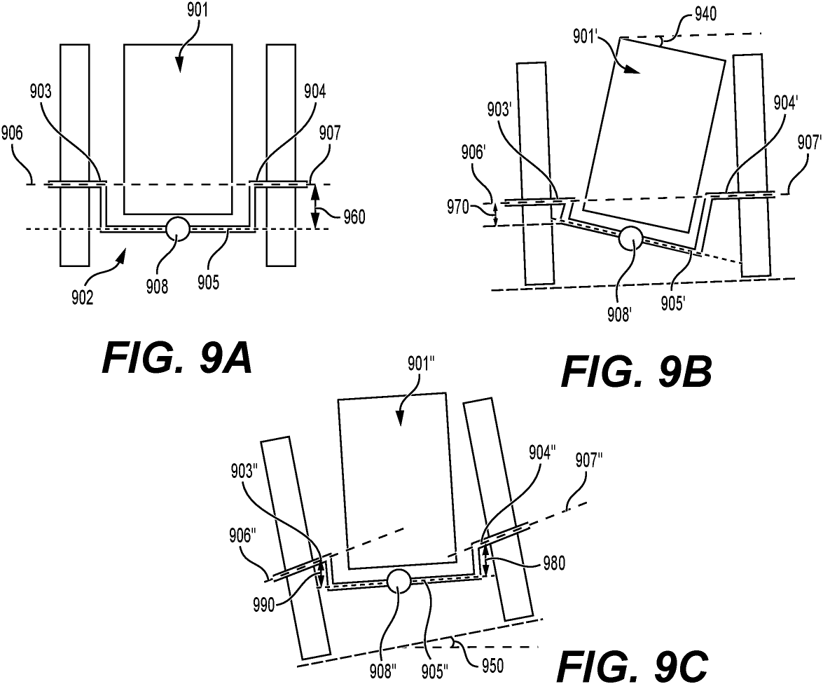

To better illustrate this, with reference to FIGS. 9A to 9C, there is depicted a variety of configurations of a non-linear axle for a wheel assembly as contemplated in at least some embodiments of the present technology.

In FIG. 9A, there is depicted a parallel configuration of a non-linear axle 902 and a frame 901. As in the embodiment illustrated on FIG. 7A, a second segment 905 of the non-linear axle 901 is located at an offset 960 from first segments 903, 904 and extends parallel to the first segments 903, 904. A pivoting axis 908 is offset from rotation axes 906, 907 in a direction normal to the inner surface of a corresponding endless track.

In FIG. 9B, there is depicted a first non-parallel configuration of a non-linear axle 902′. In this embodiment, a second segment 905′ of the non-linear axle 902′ is located at a offset 970 from first segments 903′, 904′ and but does not extend parallel to the first segments 903′, 904′. Such a configuration may be used for compensating for a camber angle 940 of a frame 901′ for instance. A pivoting axis 908′ is offset from rotation axes 906′, 907′ in a direction normal to the inner surface of a corresponding endless track.

In FIG. 9C, there is depicted a second non-parallel configuration of a non-linear axle 902″. In this embodiment, a second segment 905″ of the non-linear axle 902″ is located at a offset 980 from first segment 904″ and a offset 990 from the first segment 903″ and but does not extend parallel to the first segments 903″, 904″. Such a configuration may be used for compensating for a crowned angle 950 of a ground surface for instance. A pivoting axis 908″ is offset from rotation axes 906″, 907″ relative to an inner surface of an endless track in this configuration.

It is contemplated that in some embodiments, the first segment and the second segment of a given non-linear axle may be integrally formed from a metallic material. It is contemplated that in other embodiments, a pivoting axis of a wheel assembly may be extending longitudinally and perpendicularly to a rotation axis of a wheel the wheel assembly. In further embodiments, the pivoting axis may be further aligned with a frame segment to which a corresponding wheel assembly is rotationally and pivotably connected. In yet additional embodiments, the pivoting axis may extend through the second segment, and may be extending longitudinally and vertically below the rotation axis so as to reduce lateral movement of the wheel relative to the inner surface of the endless track.

As mentioned above, a non-linear axle may be implemented for a variety of wheel assemblies. In some embodiments, an idler wheel assembly may be implemented with a non-linear axle for reducing a distance between its pivoting axis relative to a frame and an inner surface of an endless track.

Modifications and improvements to the above-described embodiments of the present invention may become apparent to those skilled in the art. The foregoing description is intended to be exemplary rather than limiting. The scope of the present invention is therefore intended to be limited solely by the appended claims.

1-46. (canceled)

47. A pivoting assembly for a track system, the pivoting assembly comprising:
a non-linear axle and a wheel,
the non-linear axle having a first segment and a second segment,
the wheel being rotationally connected to the first segment extending along a rotation axis of the wheel, the second segment configured for pivotably connecting to a frame of the track system,
the second segment being offset from the first segment so that the second segment is closer to an inner surface of an endless track of the track system than the first segment.

48. The pivoting assembly of claim 47, wherein the pivoting assembly further has an other wheel, the non-linear axle further having an other first segment, the other first segment and the first segment disposed on opposite ends of the non-linear axle, the other wheel being rotationally connected to the other first segment extending along an other rotation axis of the other wheel.

49. The pivoting assembly of claim 47, wherein the first segment and the second segment of the non-linear axle are integrally formed from a metallic material.

50. The pivoting assembly of claim 47, wherein the second segment is configured to pivot about a pivoting axis of the pivoting assembly, the pivoting axis being perpendicular to the rotation axis of the wheel.

51. The pivoting assembly of claim 50, wherein the pivoting axis is further aligned with the frame.

52. The pivoting assembly of claim 50, wherein the pivoting axis extends through the second segment, the pivoting axis extending longitudinally and vertically below the rotation axis so as to reduce lateral movement of the wheel relative to the inner surface of the endless track.

53. The pivoting assembly of claim 47, wherein the second segment extends parallel to first segment.

54. The pivoting assembly of claim 47, wherein the second segment does not extend parallel to the first segment.

55. The pivoting assembly of claim 47, wherein the non-linear axle is a curved axle further having a curved segment connecting the first segment and the second segment.

56. The pivoting assembly of claim 55, wherein the curved segment has one of a S-shape, a Z-shape, and a L-shape.

57. The pivoting assembly of claim 47, wherein the pivoting assembly is a support wheel assembly.

58. The pivoting assembly of claim 47, wherein the pivoting assembly is a drive wheel assembly.

59. The pivoting assembly of claim 47, wherein the pivoting assembly is an idler wheel assembly.

60. The pivoting assembly of claim 47, wherein the pivoting assembly further comprises a resilient member for allowing pivoting movement of the pivoting assembly relative to the frame.

61. The pivoting assembly of claim 47, wherein the second segment is offset from the first segment in a direction that is normal to the inner surface of the endless track.

62. The pivoting assembly of claim 47, wherein the offset is a vertical offset.

63. A track system comprising:
a frame defining a longitudinal center plane;
the pivoting assembly of claim 1 being rotationally and pivotably connected to the frame; and
the endless track having the inner surface and surrounding the frame and the wheel assembly.

64. A vehicle, comprising:
a vehicle frame;
a seat disposed on the frame;
a steering system operatively connected to the frame;
a power source; and
the track system of claim 63, wherein the track system is operatively connected to the power source for driving the track system.

65. The vehicle of claim 64, wherein the second segment is offset from the first segment in a direction that is normal to the inner surface of the endless track.

66. The vehicle of claim 64, wherein the offset is a vertical offset.
